(19) United States
(12) Patent Application Publication
(10) Pub. No.: US 2004/0203583 A1
(43) Pub. Date: Oct. 14, 2004

(54) Method and system for improved event rating and wireless customer billing

(76) Inventor: Arvie Goon Man Kwan, Toronto (CA)

Correspondence Address: REDKNEE INC., 2560 MATHESON BLVD. EAST, SUITE 500, MISSISSAUGA, ON, L4W4W9, CA

(21) Appl. No.: 10/281,167

(22) Filed: Oct. 28, 2002

(51) Int. Cl. H04M 11/00; H04M 11/10; H04M 3/42

(52) U.S. Cl. 455/406; 455/413; 455/414.1

(57) ABSTRACT

Among mobile service providers and indeed, general industry literature, there exists a known limitation of select prepaid platforms (as Nortel Service Builder™ for instance) and related prepaid network configuration(s) whereby prepaid subscribers are charged for airtime when incoming calls are forwarded to their voicemail boxes. The deficiency in the art is due to said platforms' inability to distinguish whether a call to a subscriber's mobile phone was in fact forwarded to the said mobile service provider/operator's voicemail system. The invention of present remains directed toward addressing the limitations and deficiencies of the existing art, and more generically to implementing a solution for re-crediting such incremental charges back to the said pre-paid wireless subscriber. Indeed, the method and system disclosed herein utilize said mobile service provider's existing infrastructure as well as existing telecommunications interfaces, protocols and the like. No modification to the provider's voicemail system, third-party proprietary prepaid platforms or other such matter is required.

### TECHNICAL FIELD

The present invention relates generally to telecommunication and wireless network implementations, and, in particular, a method and system for improved event rating and wireless customer billing.

### SUMMARY OF THE INVENTION

In remedying the existing limitations of certain prepaid platforms (of which, Nortel's Service Builder™ remains an example), a method and system is disclosed wherein the amount charged to a given wireless subscriber's account for airtime during message deposits to their respective voicemail boxes by inbound callers, is credited. Specifically, Event Records (ER) generated by the voicemail systems for both prepaid and postpaid subscribers are processed on a periodic basis (fifteen (15) minutes for instance) to determine the amount(s) to be credited to the given subscriber's account.

The Rating Application (RA) would retrieve ERs from various voicemail systems located throughout the mobile operator/provider's network. These records would be processed with a view towards updating and modifying the given subscriber account.

The technological advances over the existing art achieved by this disclosure would permit mobile and/or network operators which utilize Intelligent Network (IN) infrastructure to enhance their system for prepaid billing and for the rating of voicemail services without much (potential or realized) operational impact.

Indeed, it is evident that the Rating Application (RA) remains at the core of the art seeking protection by Letters Patent and as such, its features and other such advantages of the present invention shall be further elucidated in the following description and accompanying drawings.

### BRIEF DESCRIPTION OF THE DRAWINGS

FIG. 1 illustrates a typical, non-limiting embodiment of the system level architecture employed in the articulation of the present invention;

FIG. 2 depicts a more detailed view of the rating application and related art employed in the present invention.

### DETAILED DESCRIPTION OF THE PREFERRED EMBODIMENTS

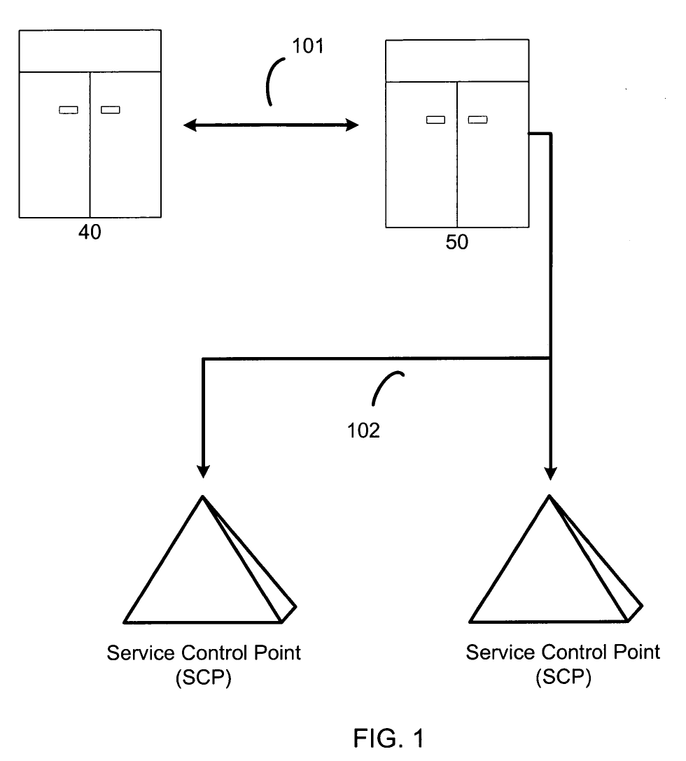

With reference to FIG. 1, which details the architectural overview of the voicemail credit adjustment process, the Rating Application (RA) 50 processes the Call Detail Record (CDR) file as retrieved periodically 101 from the OAM component of the aforementioned voicemail system 40. The retrieval period remains largely arbitrary, although in practice the art may be constrained by the time periods for which CDR files are generated/updated on sundry voicemail systems and platforms.

As the CDR file will ordinarily contain Call Detail Records of all voicemail events; it remains an operational aspect of the RA 50 to filter and process only those events which satisfy certain criteria. A typical, but non-exhaustive list would include:

1) Call Detail Record for Guest Session (Message Deposit)

2) Voicemail deposit left via Call Forwarding

3) Prepaid subscriber

The CDRs would then be rated and a credit 102 applied to the subscriber's account.

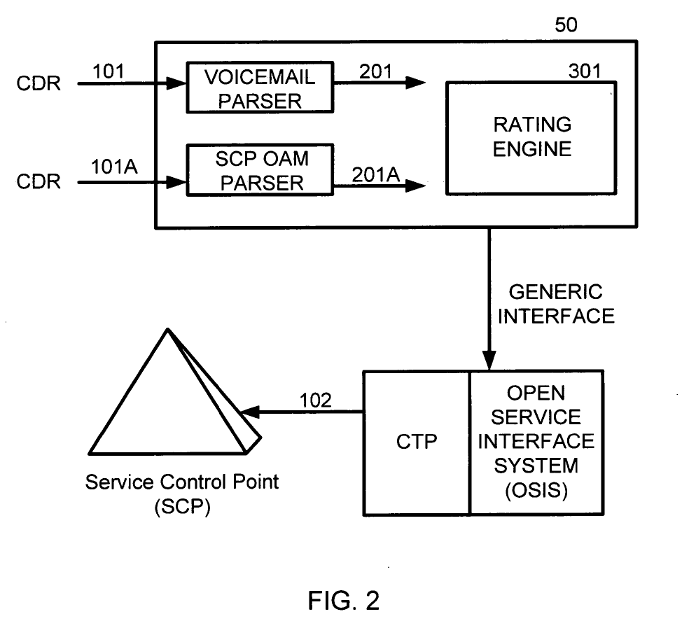

Now with reference to FIG. 2, at 101 and 101A the CDRs are polled from the requisite voicemail system and SCP OAM. At 201 the voicemail CDRs are parsed to extract, in the preferred embodiment, MSISDN (originating), MSISDN (terminating), call duration, call start time and call end time. At 201A the SCP OAM ‘Termination Account Update’ Event Records (ER) are parsed to extract MSISDN (originating), MSISDN (terminating), Cost of call/Amount Debited, and time.

As part of the RA 50, the Rating Engine 301 correlates ER/CDR information from the SCP and voicemail system to verify amount to credit subscribers. And before with FIG. 1, at 102 the said subscriber's prepaid account balance is incremented to credit for voicemail deposit usage.

Indeed, the post-event nature of the solution does not necessarily prevent malicious voicemail system usage, whereby prepaid accounts can be intentionally depleted (albeit temporarily). To minimize the impact on subscribers, however, the event record polling can be configured to reduce the latency between the voice mail deposit and account credit update. In alternate embodiments, there remains scope to incorporate the use of MWI (Message Waiting Indicator) triggers to identify prepaid voice mail activity. Though it may provide a near real-time solution with reduced latency, the use of the MWI does not alleviate the requirements for a SCP/VM ER correlation-type solution, as a high percentage of callers terminate the call before a message is recorded, negating the ability to utilize MWI. In addition to only addressing a percentage of overall prepaid voice mail traffic, the use of MWI still faces latency issues during busy hour traffic to the SMSC.

What is claimed is:

1. An open architecture method and system for improved event rating and subscriber billing.

2. The system of claim 1, wherein said event rating and subscriber billing relate to wireless and/or mobile telephony.

3. The system of claim 1, whereby wireless subscriber accounts are re-credited for airtime improperly decremented from said accounts when incoming calls are forwarded to their respective voicemail boxes.

4. The system of claim 3, which remains unique to select, identified prepaid platforms and related network configurations.

5. The system of claim 3, wherein records are generated by the voicemail system in question for both prepaid and postpaid subscribers.

6. The system of claim 5, where said records can be captured as Event Records (ER) or, in the alternate, as Call Detail Records (CDR).

7. The system of claim 5, where said records are processed on a periodic basis (fifteen (15) minutes for instance) to determine the amount(s) to be credited to the given subscriber's account.

8. The method of claim 3, comprising a computer program product (‘Rating Application’) for implementing said architecture on a computer readable memory medium and a computer program including instructions for parsing and translation.

9. The method of claim 6, wherein said Rating Application would retrieve ERs from various voicemail systems located throughout the mobile operator's network.

10. The method of claim 9, where said ERs are processed with a view towards updating and modifying the given wireless subscriber's account.

11. The method of claim 10, wherein said wireless subscriber's account balance is incremented to credit for voicemail deposit usage.
